(19) United States
(12) Patent Application Publication
(10) Pub. No.: US 2006/0283910 A1
(43) Pub. Date: Dec. 21, 2006

(54) Electrically operated drive-in tool

(75) Inventors: Ulrich Schiestl, Feldkirch (AT); Hans Gschwend, Buchs (CH)

Correspondence Address: ABELMAN, FRAYNE & SCHWAB, 666 THIRD AVENUE, 10TH FLOOR, NEW YORK, NY, 10017, US

(73) Assignee: Hilt Aktiengesellschaft

(21) Appl. No.: 11/450,735

(22) Filed: Jun. 9, 2006

(30) Foreign Application Priority Data
Jun. 16, 2005 (DE) 10 2005 000 077.0

(51) Int. Cl. B25C 1/04

(52) U.S. Cl. 227/131; 227/130

(57) ABSTRACT

A drive-in tool (10) for driving in fastening elements (60) includes a driving ram (13) which is displaceably supported in a guide (12), a drive unit (30) for the driving ram (13) and having at least one drive flywheel (32) which is set in rotation by an electric motor (31), and a return element (70) for displacing the driving ram (13) its initial position (22) after the completion of the drive-in process and formed as an over-pressure gas spring (70).

### BACKGROUND OF THE INVENTION

1. Field of the Invention

The invention is directed to an electrically operated drive-in tool having a ram for driving in a fastening element and supported in a guide for displacement therein, a drive unit for driving the ram and having at least one flywheel driven by an electric motor, and a return device for returning the ram in its initial position upon completion of the drive-in process. In drive-in tools of this type, fastening elements are driven into a substrate by a driving movement of the driving ram.

2. Description of the Prior Art

In the electrically operated drive-in tools, the driving ram is accelerated by at least one flywheel which can be driven by an electric motor. In drive-in tools which draw their energy from a battery, the driving energy is approximately 35 J to 40 J. According to the flywheel principle realized in the drive-in tools, the energy stored in the flywheel is transmitted to the driving ram by a clutch. This clutch must be switched very quickly and must transmit a very high energy within a very short time. Further, the clutch must be switched off again very quickly at the end of the drive-in process. The driving piston is moved back at the end of the drive-in process, e.g., by a spring element or a flexible belt.

U.S. Pat. No. 4,721,170 discloses an electric drive-in tool in which the driving ram is guided through between a flywheel, which is driven by an electric motor, and an idler wheel. A flexible belt which acts on the driving ram, on one hand, and is held at the housing, on the other hand is provided for returning the driving ram to its initial position after a drive-in process has been completed.

However, returning the driving ram with a flexible belt is only practical in drive-in tools with low setting power. In drive-in tools with higher driving energies for the driving ram greater than about 35 J, the life of the flexible belt is drastically reduced.

U.S. Pat. No. 4,129,240 discloses another electric drive-in tool in which a driving ram can be driven by a flywheel which is driven by an electric motor. A return device for the driving ram comprises a return wheel that is held at a supporting arm. This return wheel is switchable between an active position, in which it is driven by a shaft of the flywheel and engages the driving ram, and an inactive position in which it is lifted from the driving ram and is not driven by the shaft of the flywheel.

This is disadvantageous in that the mechanism for switching the return wheel is very complicated and slow.

Further, it is known from U.S. Pat. No. 4,129,240 to return the driving ram with a return spring which engages the housing, on one hand, and the driving ram, on the other hand.

The drawback of the device of this U.S. Patent consists that the mechanical return spring does not have the required useful life in drive-in tools with a setting power greater than about 35 J. Further, the mass of the spring leads to drastic energy losses.

International Publication WO 02/051593 A1 discloses an electrically operated drive-in tool in which a vacuum spring is used for returning the driving ram to its initial position.

The drawback of the drive-in tool of the Publication WO 02/05593 A1 consists in that the use of a vacuum spring is limited by its dimensions. Therefore, only very small return forces can be obtained with the vacuum spring, as the vacuum always amounts maximum to 1 bar.

Accordingly, an object of the present invention is a drive-in tool of the type mentioned above which insures a reliable return of the diving ram at higher driving energies, greater than 35 J, and which has an adequate useful service life.

### SUMMARY OF THE INVENTION

This and other objects of the present invention, which will become apparent hereinafter, are achieved by providing a return device formed as an over-pressure gas spring. An over-pressure gas spring with the same volume as a vacuum spring permits to obtain significantly greater return forces than the vacuum spring. The advantage of an over-pressure gas spring in comparison with a mechanical spring consists in that it does not have any energy losses as its mass is very small. An over-pressure gas spring has a very simple construction and can be easily manufactured.

Advantageously, the over-pressure gas spring has a cylinder and a piston displaceable in the cylinder and confining therein gas that fills the cylinder. The piston-cylinder principle insures a good leak tightness of the over-pressure spring. In addition, seal rings or piston rings can be arranged between the piston and the cylinder for increasing the tightness.

Advantageously, the cylinder is mounted on the driving ram, and the piston is connected, at its end remote from the cylinder, with the housing. Thereby, the existing series of the drive-in tool can be provided with the inventive return device by a very slight modification. To this end, practically, hardly any additional constructional space is needed. It should be understood that the arrangement of the cylinder and the piston can be reversed, i.e., the piston can be arranged on the driving ram, and the cylinder can be connected with the housing.

It is further advantageous when the overpressure gas spring is loaded by the driving ram. In this case, the over-pressure gas spring is loaded automatically during the drive-in process by the driving ram displaceable in the drive-in direction. A separate loading device is not necessary.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

In the Drawings:

FIG. 1 shows a longitudinal cross-sectional view of a drive-in tool according to the present invention in an actuated position;

FIG. 2 shows a view similar to that of FIG. 1, with the driving ram returned to its initial position.

### DETAILED DESCRIPTION OF THE PREFERRED EMBODIMENTS

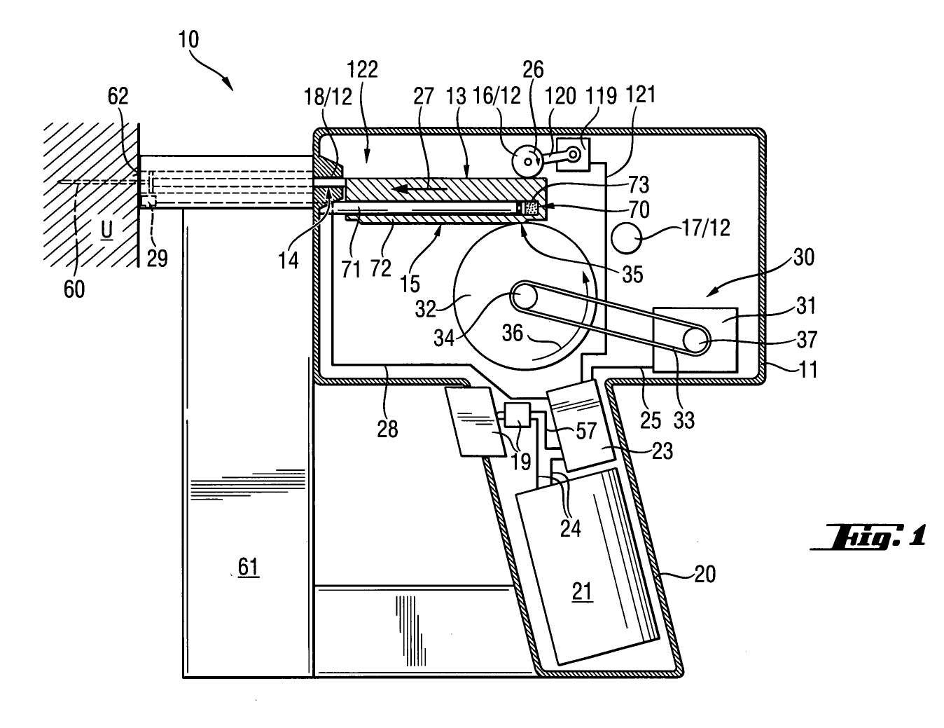

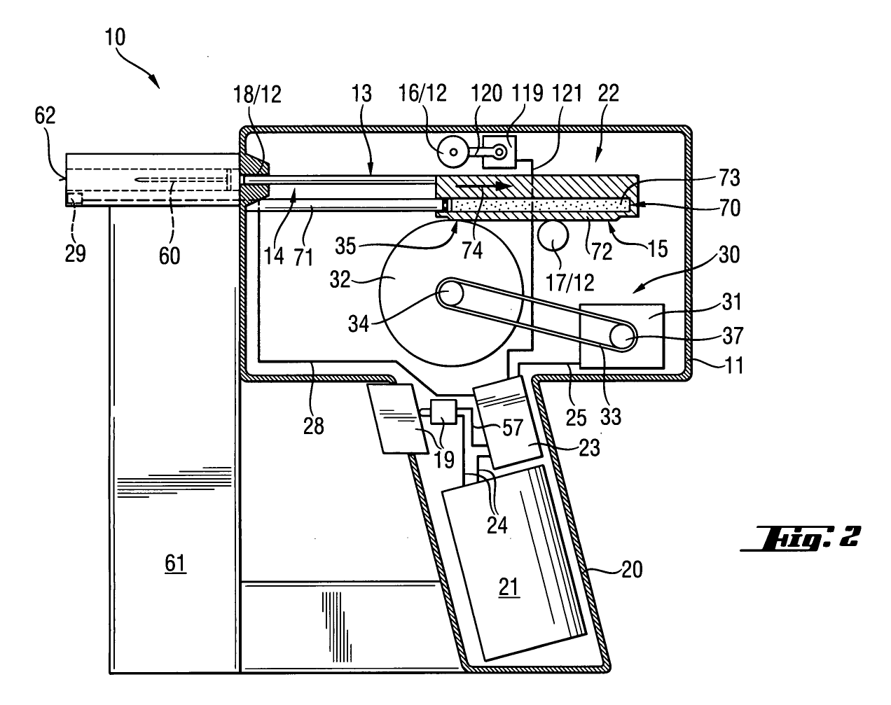

The drive-in tool 10, which is shown in FIGS. 1 and 2, has a housing 11 and a drive unit, designated in its entirety with a reference numeral 30 and which is arranged in the housing 11 for driving a driving ram 13 which displaceable in a guide 12. The guide 12 has a guide roller 17, contact pressing means 16 which is formed as a contact pressing roller, and a guide channel 18. A fastening element magazine 61, in which fastening elements 60 are loaded, is arranged at the end of the guide 12 in the driving direction 27 so as to project laterally therefrom.

Further, the drive-in tool 10 has a handle 20 on which a trigger switch 19 is arranged for triggering a drive-in process with the drive-in tool 10. A power supply, designated in its entirety by 21, is arranged in the handle 20 and supplies the drive-in tool 10 with electrical energy. The power supply 21 has at least one battery in the present case. The power supply 21 is connected to a control unit 23 and to the trigger switch 19 by power conductors 24. Further, the control unit 23 is connected to the trigger switch 19 with a switch conductor 57.

Another switch means 29 is arranged at a mouth 62 of the drive-in tool 10 and is electrically connected to the control unit 23 by a conductor 28. The switch means 29 transmits an electric signal to the control unit 23 as soon as the drive-in tool 10 is pressed against a substrate U, as can be seen from FIG. 1, and accordingly ensures that the drive-in tool 10 can only be triggered when it has been pressed against a constructional component U in the proper manner.

The drive unit 30 comprises an electrically operated motor 31 with a motor shaft 37. The motor shaft 37 transmits a rotational movement of the motor 31 to a bearing pin 34 of a drive flywheel 32 by transmission means 33 which is formed, e.g., as a belt and sets the drive flywheel 32 in rotational movement in the direction indicated by arrow 36. The motor 31 is supplied and switched directly by the control unit 23 via an electric motor conductor 25. For example, the motor 31 can be put into operation by the control unit 23 already when the drive-in tool 10 is pressed against a constructional component U and a corresponding signal is sent from the switch means 29 to the control unit 23 via the conductor 28. Further, a drive coupling 35, which is formed as a friction clutch, acts between the drive flywheel 32 and the driving ram 13. This drive coupling 35 comprises a coupling section 15 of the driving ram 13 which is wider than a front driving section 14 and which can be brought into frictional engagement with the drive flywheel 32 by the contact pressing means 16. The contact pressing means 16 is rotatably supported on a bearing arm 120 which can be raised or lowered by actuating means 119 formed, e.g., as a servomotor, stepping motor or solenoid. The actuating means 119 is connected to the control unit 23 by a control conductor 121. During a movement of the driving ram 13, the contact pressing means 16 can rotate in the direction indicated by arrow 26 and can roll on the driving ram 13 so as not to brake the latter.

Further, a return device, which is formed as an over-pressure gas spring 70, is provided in the drive-in tool 10 for returning the driving ram 13 to its initial position. The over-pressure gas spring 70 has a cylinder 72 which is arranged in the coupling section 15 of the driving ram 13, and a rod-shaped piston 71 displaceable in the cylinder 72. The piston 71 is connected, at its end remote from the cylinder 72, with the housing 11 and closes gas 73 that fills the cylinder 72, medium tight.

When the drive-in tool 10 is pressed against a constructional component U, as can be seen in FIG. 1, the motor 31 of the drive unit 30 is initially switched on by the switch means 29 and the control unit 23, and the drive flywheel 32 is set in rotation in the rotational direction indicated by arrow 36 (see FIG. 1) by the motor 31.

When the trigger switch 19 is subsequently actuated by an operator, the actuating means 119 are activated by the control unit 23 via the control conductor 121. The contact pressing means 16 at the bearing arm 120 is then moved in the direction of the driving ram 13 by the actuating means 119. The driving ram 13 is accordingly moved to the drive flywheel 32 with its coupling section 15 so that the drive coupling 35 becomes engaged and the driving ram 13 is accelerated in the driving direction by the drive flywheel 32. During the drive-in displacement of the driving ram 13, the piston 71 is displaced into the cylinder 72, compressing the gas 73 located in the cylinder 71. As result, the over-pressure gas spring 70 becomes loaded.

In the end position 122 of the driving ram 13, the control unit 23 communicates a signal to the actuating means 119 via the control conductor 121, activating the actuating means 119. The actuating means 119 lifts the pressing means 16 off the driving ram 13, whereby the drive coupling 35 is deactivated (see FIG. 2). As a result, the over-pressure gas spring 70 displaces the driving ram 13 in the direction of arrow 74 back to its initial position. The return movement can be carried out very rapidly because the gas pressure in the loaded over-pressure gas spring 70 amounts to from about 3 bar to 20 bar. The driving ram 13 is now again located in its initial position 22 shown in FIG. 2 and in which it is possible to carry out a new drive-in process with the drive-in tool 10.

Though the present invention was shown and described with references to the preferred embodiment, such is merely illustrative of the present invention and is not to be construed as a limitation thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. An electrically operated drive-in tool for driving-in fastening elements, comprising a guide (12); a ram (13) displaceably supported in the guide (12) for driving the fastening elements; a drive unit (30) for driving the ram (13) and including a drive flywheel (32) and an electric motor (31) for rotating the drive flywheel (32); and return means for displacing the driving ram (13) to an initial position (22) thereof and formed as an over-pressure gas spring (70).

2. A drive-in tool according to claim 1, wherein the over-pressure gas spring (70) comprises a cylinder (72); gas (73) filing the cylinder (72); and a piston (71) displaceable in the cylinder (72) and confining the gas (73) therein.

3. A drive-in tool according to claim 1, wherein the cylinder (72) is arranged on the driving ram (13), and the piston (71) is fixedly connected, at an end thereof remote from the cylinder (72) with the housing (11).

4. A drive-in tool according to claim 1, wherein the over-pressure gas spring (70) becomes loaded upon displacement of the driving ram (13) in a drive-in direction.
